(19) United States
(12) Patent Application Publication
(10) Pub. No.: US 2014/0295871 A1
(43) Pub. Date: Oct. 2, 2014

(54) APPARATUS AND METHOD FOR CONTROLING IN-DEVICE COEXISTENCE INTERFERENCE IN WIRELESS COMMUNICATION SYSTEM

(71) Applicant: PANTECH CO., LTD., Seoul (KR)

(72) Inventors: Jae Hyun Ahn, Mapo-gu (KR); Ki Bum Kwon, Mapo-gu (KR); Myung Cheul Jung, Mapo-gu (KR)

(73) Assignee: PANTECH CO., LTD. a corporation

(21) Appl. No.: 14/355,897

(22) PCT Filed: Nov. 2, 2012
(86) PCT No.: PCT/KR2012/009209

§ 371 Date: May 2, 2014

(30) Foreign Application Priority Data
Nov. 3, 2011 (KR) 10-2011-0114188

(51) Int. Cl. H04W 72/12

(52) U.S. Cl. CPC H04W 72/1215
USPC 455/452.1

(57) ABSTRACT

In the present invention, a method or device of controlling in-device coexistence interference is described. The present invention includes receiving from a base station measurement configuration information including an IDC triggering threshold used for the condition of triggering an event indicating whether on-going IDC has been initiated; performing each of measurement considering IDC and measurement not considering IDC based on the measurement configuration information; triggering the event when a difference between a result of the measurement considering IDC and a result of the measurement not considering IDC is larger than the IDC triggering threshold; and reporting to the base station an IDC indication indicating whether the event is triggered and the results of the measurements.

### CROSS-REFERENCE TO RELATED APPLICATIONS

This application is the National State Entry of International Application No. PCT/KR2012/009209, filed on Nov. 2, 2012, and claims priority from and the benefit of Korean Patent Application No. 10-2011-0114188, filed on Nov. 3, 2011, both of which are hereby incorporated by reference for all purposes as if fully set forth herein.

### BACKGROUND

1. Field

The present invention concerns wireless communication systems, and more specifically to an apparatus and method of controlling coexistence interference in a device in a wireless communication system.

2. Discussion of the Background

A wireless communication system generally uses one bandwidth for transmitting data. For example, a 2-generation wireless communication system uses a bandwidth in the range of 200 KHz to 1.25 MHz and a 3-generation wireless communication system uses a bandwidth in the range of 5 MHz to 10 MHz. In order to support an increased transmission capacity, 3rd generation partnership project (3GPP) long term evolution (LTE) or IEEE 802.16m has extended a bandwidth thereof up to 20 MHz or more in recent years. The bandwidth may need to increase so as to increase the transmission capacity, but supporting a large bandwidth even when a required service level is low may cause large power consumption.

Therefore, a multiple component carrier system has appeared, which defines a carrier having one bandwidth and one center frequency, and can transmit or receive data in a wideband through a plurality of carriers. A narrowband and the wideband are simultaneously supported by using one or more carriers. For example, when one carrier corresponds to a bandwidth of 5 MHz, a bandwidth of maximum 20 MHz is supported by using four carriers.

Due to a ubiquitous connection network of today, user can access different networks in different regions and continuously keep connectivity wherever. In the related art in which one terminal communicates with one network system, the user carried different equipments supporting respective network systems. However, in recent years, as functions of a single terminal have been advanced and complicated, the user can communicate with a plurality of network systems simultaneously by using only the single terminal and user convenience has increased.

However, when one terminal performs communication on a plurality of network system bands simultaneously, In-Device Coexistence interference (IDC) may occur. The in-device coexistence interference (IDC) means interference when transmission in any one frequency band interferes in reception in another frequency band. For example, the in-device coexistence interference may occur between a Bluetooth system band and a 802.16 system band when one terminal supports both a Bluetooth system and a 802.16 system. The in-device coexistence interference may occur primarily when a spacing interval of a frequency band boundary of a heterogeneous network system is not sufficiently large. In this regard, various in-device coexistence interference avoidance (ICO) techniques are proposed.

### SUMMARY

A technical object of the present invention is to provide an apparatus and method of controlling coexistence interference in a device.

Another technical object of the present invention is to provide an apparatus and method of transmitting configuration information of a terminal so as to perform a control operation on coexistence interference in a device.

Still another technical object of the present invention is to provide an apparatus and method of triggering an event that indicates occurrence or termination of coexistence interference in a device.

Still another technical object of the present invention is to provide an apparatus and method of transmitting indicator indicating occurrence or termination of coexistence interference in a device.

Still another technical object of the present invention is to provide an apparatus and method of receiving threshold value for entry and release of coexistence interference in a device.

Still another technical object of the present invention is to provide an apparatus and method of measuring neighbor cell and primary/secondary cell for detecting coexistence interference in a device.

Still another technical object of the present invention is to provide an apparatus and method of comparing measurement of neighbor cell and measurement of primary/secondary cell for detecting coexistence interference in a device.

Still another technical object of the present invention is to provide an apparatus and method of measuring by distinguishing sample considering IDC and sample not considering IDC.

According to an aspect of the present invention, a method of controlling in-device coexistence interference by a terminal in a wireless communication system, the method comprising the steps of: receiving from a base station measurement configuration information including an IDC triggering threshold used for the condition of triggering an event indicating whether on-going IDC has been initiated; performing each of measurement considering IDC and measurement not considering IDC based on the measurement configuration information; triggering the event when a difference between a result of the measurement considering IDC and a result of the measurement not considering IDC is larger than the IDC triggering threshold; and reporting to the base station an IDC indication indicating whether the event is triggered and the results of the measurements.

According to another aspect of the present invention, a method of controlling in-device coexistence interference (IDC) by a base station in a wireless communication system, the method comprising the steps of: transmitting to a terminal measurement configuration information including a condition for triggering an event that indicates whether on-going IDC has been initiated; receiving from the terminal an IDC indication indicating whether the event is triggered and a result of measurement performed based on the measurement configuration information; determining an IDC control operation based on the result of the measurement and the IDC indication; and transmitting the IDC control operation to the terminal.

According to yet another aspect of the present invention, a terminal that controls in-device coexistence interference (IDC) in a wireless communication system, the terminal comprising: a reception unit receiving from a base station measurement configuration information including an IDC triggering threshold used on the condition of triggering an event indicating whether on-going IDC has been initiated; a measurement unit performing each of measurement considering IDC and measurement not considering IDC based on the measurement configuration information; a triggering unit triggering the event when a difference between a result of the measurement considering IDC and a result of the measurement not considering IDC is larger than the IDC triggering threshold; and a transmission unit reporting to the base station an IDC indication indicating whether the event is triggered and the results of the measurements.

According to yet another aspect of the present invention, a base station that controls in-device coexistence interference (IDC) in a wireless communication system, the base station comprising: a transmission unit transmitting to a terminal measurement configuration information including a condition for triggering an event that indicates whether on-going IDC has been initiated; a reception unit receiving from the terminal an IDC indication indicating whether the event is triggered and a result of measurement performed based on the measurement configuration information; an interference control determination unit determining an IDC control operation based on the measurement report information.

According to the present invention, an event may be generated that indicates occurrence or termination of coexistence interference in a device over a wireless network.

According to the present invention, coexistence interference in a device may be avoided.

According to the present invention, triggering may be properly performed so that the operation of controlling coexistence interference in a device is not conducted too frequently or infrequently.

### BRIEF DESCRIPTION OF THE DRAWINGS

FIG. 1 illustrates a wireless communication system according to exemplary embodiments of the present invention.

FIG. 2 is an explanatory diagram describing in-device coexistence interference.

FIG. 3 is an example illustrating the in-device coexistence interference from an industrial, scientific and medical transmitter to an LTE receiver.

FIG. 4 is an example in which a band is divided into an ISM band and an LTE band on a frequency band.

FIG. 5 is an explanatory diagram illustrating one example of alleviating the in-device coexistence interference by using an FDM scheme according to the present invention.

FIG. 6 is an explanatory diagram illustrating another example of alleviating the in-device coexistence interference by using the FDM scheme according to the present invention.

FIGS. 7 and 8 are explanatory diagrams illustrating one example of alleviating the in-device coexistence interference by using a power control scheme according to the present invention.

FIG. 9 is an explanatory diagram illustrating one example of alleviating the in-device coexistence interference by using the time division multiplex scheme according to the present invention.

FIG. 10 is an explanatory diagram illustrating one example of transmission/reception timings on time axes in the LTE band and the ISM band using the TDM scheme according to the present invention.

FIG. 11 is a diagram illustrating another example of alleviating the in-device coexistence interference by using the TDM scheme according to the present invention.

FIG. 12 is a diagram illustrating yet another example of alleviating the in-device coexistence interference by using the TDM scheme according to the present invention.

FIG. 13 is a diagram illustrating yet another example of alleviating the in-device coexistence interference according to the present invention.

FIG. 14 is a flowchart illustrating an exemplary operation of a terminal and a base station that perform in-device coexistence interference control.

FIG. 15 shows cases where a terminal receives an in-device interference signal.

FIG. 16 is a view illustrating performing measurement without consideration of in-device coexistence interference and measurement considering in-device coexistence interference according to the present invention.

FIG. 17 is a flowchart illustrating a terminal's operation of controlling in-device coexistence interference according to the present invention.

FIG. 18 is a flowchart illustrating an operation of a base station to control in-device coexistence interference according to the present invention.

FIG. 19 is a block diagram illustrating an apparatus of transmitting and receiving information regarding in-device coexistence interference according to an embodiment of the present invention.

### DETAILED DESCRIPTION OF THE ILLUSTRATED EMBODIMENTS

Hereinafter, in this specification, some exemplary embodiments will be described in detail with reference to the accompanying drawings. In adding reference numerals to components throughout the drawings, it is to be noted that like reference numerals designate like components even though components are shown in different drawings. Further, in describing the present invention, well-known functions or constructions will not be described in detail since they may unnecessarily obscure the understanding of the present invention.

Further, in describing components of the specification, terms such as first, second, A, B, (a), (b), and like may be used. These terms are just used to discriminate the components from other components and a property, an order, or a sequence of the corresponding component is not limited by the term. It will be understood that when an element is simply referred to as being “connected to” or “coupled to” another element without being “directly connected to” or “directly coupled to” another element in the present description, it may be “directly connected to” or “directly coupled to” another element or be connected to or coupled to another element, having the other element intervening there between.

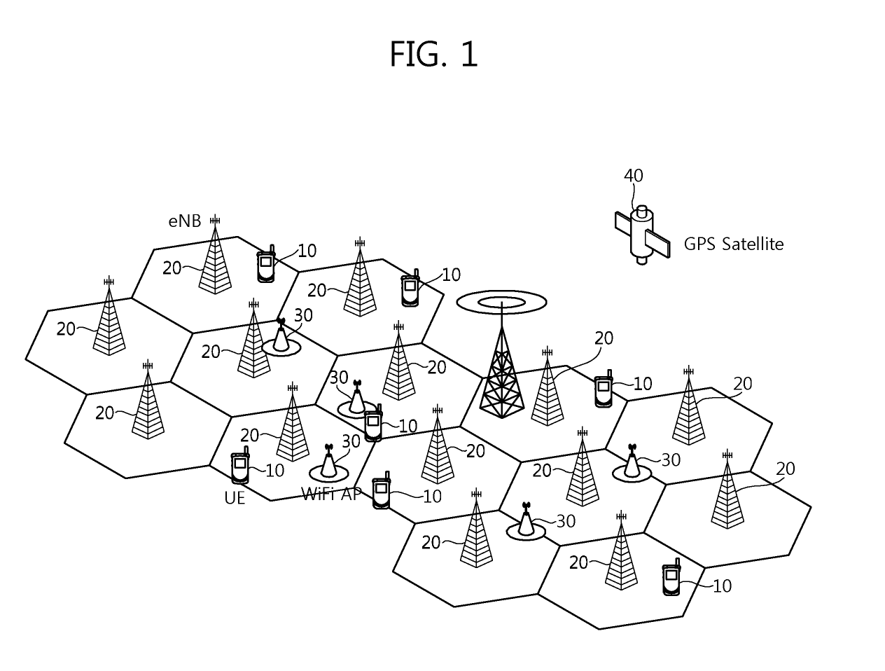

FIG. 1 illustrates a wireless communication system according to exemplary embodiments of the present invention.

Referring to FIG. 1, the wireless communication system is widely placed in order to provide various communication services including voice, packet, data, and the like, and includes a terminal (also may called as a user equipment (UE)) 10, a base station (BS, or called as a evolved NodeB (eNB)) 20, a wireless LAN access point (AP) 30, a global positioning system (GPS) 40, and a satellite. Herein, a wireless LAN is a device supporting IEEE 802.11 technology which a wireless standard and the IEEE 802.11 may be mixed with a WiFi system.

The UE 10 may be positioned in coverage of a plurality of networks including a cellular network, a wireless LAN broadcast network, a satellite system, and the like. The UE 10 is provided with a plurality of wireless transceivers in order to access various networks and various services regardless of place and time. For example, a smart phone is provided with long term evolution (LTE), WiFi Bluetooth transceiver, and a GPS receiver. A design of the UE 10 becomes more complicated in order to integrate more and more transceivers in one same UE 10 while maintaining excellent performance. As a result, a possibility that in-device coexistence interference (IDC) in the UE will occur may be further increased.

Hereinafter, a downlink (DL) indicates communication from the eNB 20 and an uplink (UL) indicates communication from the UE 10 to the eNB 20. In the downlink, a transmitter may be a part of the eNB 20 and a receiver may be a part of the UE 10. In the uplink, the transmitter may be a part of the UE 10 and a receiver may be a part of the eNB 20.

The UE 10 may be fixed or have mobility, and may be called other terms such as a mobile station (MS), a user terminal (UT), a subscriber station (SS), a mobile terminal (MT), a wireless device, and the like. The eNB 20 indicates a fixed station that communicates with the UE 10 and may be called other terms such as a base station (BS), a base transceiver system (BTS), an access point, a femto base station (BS), a relay, and the like.

Multiple access techniques applied to the wireless communication system are not limited. Various multiple access techniques such as CDMA (Code Division Multiple Access), TDMA (Time Division Multiple Access), FDMA (Frequency Division Multiple Access), OFDMA (Orthogonal Frequency Division Multiple Access), SC-FDMA (Single Carrier-FDMA), OFDM-FDMA, OFDM-TDMA, and OFDM-CDMA may be used. In uplink transmission and downlink transmission, a time division duplex (TDD) scheme in which transmission is performed by using different times may be used or a frequency division duplex (FDD) scheme in which transmission is performed by using different frequencies may be used.

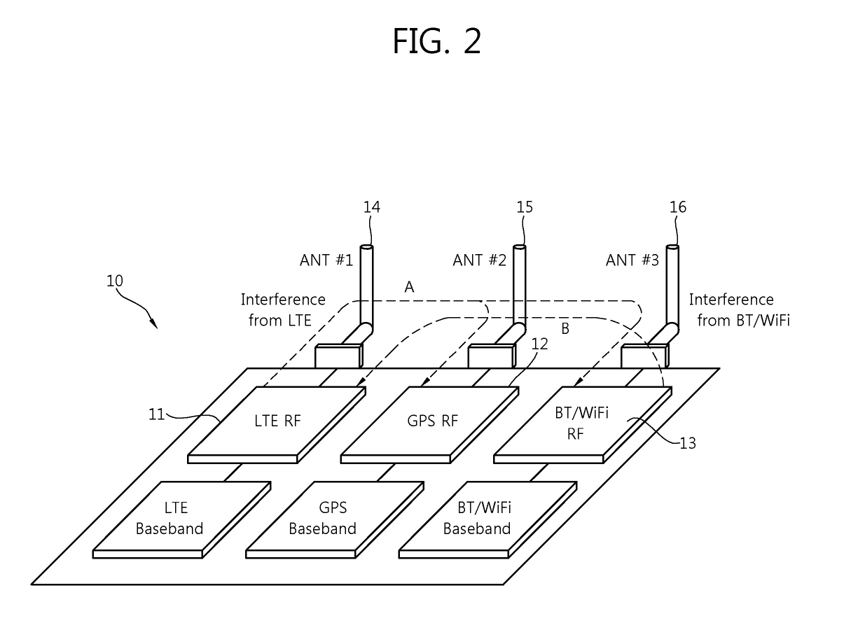

FIG. 2 is an explanatory diagram describing in-device coexistence interference.

Referring to FIG. 2, the eNB 20 includes an LTE RF 21, a GPS RF 22, and a Bluetooth/WiFi RF 23. Transceiving antennas 24, 25, and 26 are connected to the respective RFs. That is, various types of RFs are closely mounted in one device platform. Herein, transmission power of one RF may be much larger than a reception power level into another RF receiver. In this case, if an interval in frequency between the RFs is not sufficient and a filtering technique is not supported, a transmission signal of any RF may cause remarkable interference in a receiver of another RF within the device. For example, “(1)” is an example in which the transmission signal of the LTE RF 21 causes the in-device coexistence interference in the GPS RF 22 and the Bluetooth/WiFi RF 23 and “(2)” is an example in which the transmission signal of the Bluetooth/WiFi RF 23 causes the in-device coexistence interference in the LTE RF 21.

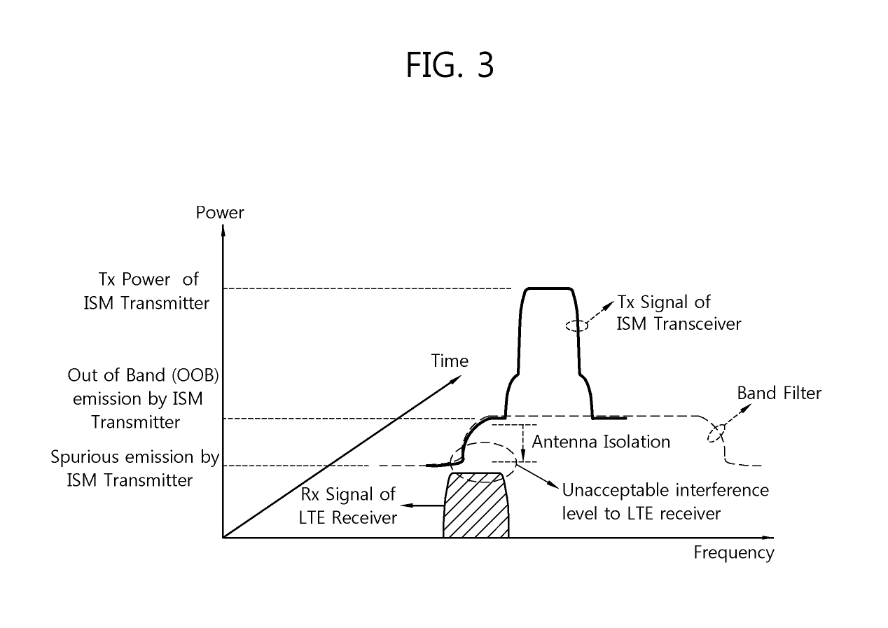

FIG. 3 is an example illustrating the in-device coexistence interference from an industrial, scientific and medical (ISM) transmitter to an LTE receiver. The ISM band indicates a band which may be arbitrarily used without authorizing the use in industrial, scientific, and medical fields.

Referring to FIG. 3, a band of a signal received by the LTE receiver overlaps with a band of a transmission signal of the ISM transmitter. In this case, the in-device coexistence interference may occur.

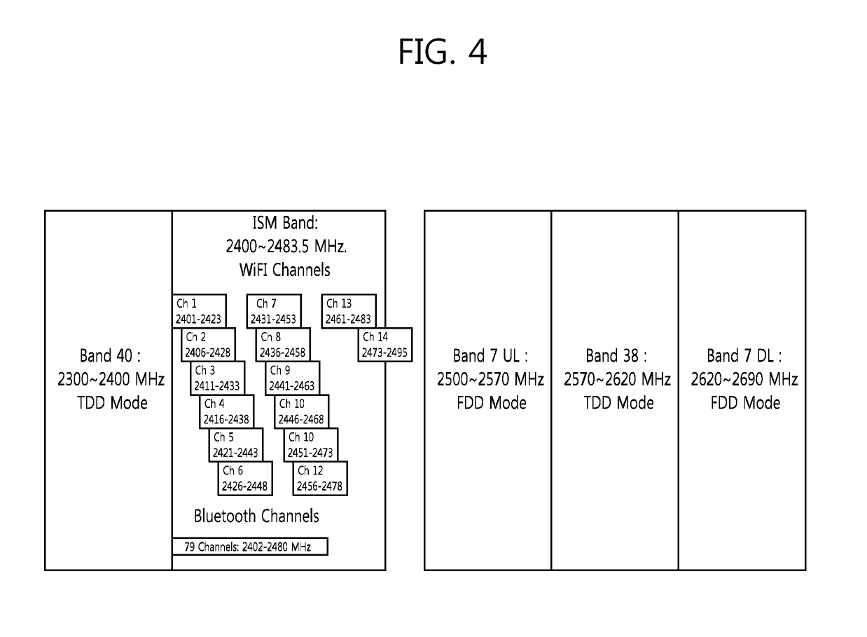

FIG. 4 is an example in which a band is divided into an ISM band and an LTE band on a frequency band.

Referring to FIG. 4, a band 40, a band 7, and a band 38 are LTE bands. The band 40 occupies a band in the range of 2300 to 2400 MHz in a TDD mode and the band 7 occupies a band in the range of 2500 to 2570 MHz as the uplink in an FDD mode. In addition, the band 38 occupies a band in the range of 2570 to 2620 MHz in the TDD mode. Meanwhile, the ISM band is used as a WiFi channel and a Bluetooth channel, and occupies a band in the range of 2400 to 2483.5 MHz. Herein, a condition in which the in-device coexistence interference occurs is illustrated in Table 1 below.

TABLE 1

| Interference | |
|---|---|
| band | Pattern of interference |
| Band 40 | ISM Tx −> LTE TDD DL |
| | Rx |
| Band 40 | LTE TDD UL Tx −> ISM |
| | Rx |
| Band 7 | LTE FDD UL Tx −> ISM Rx |
| Band 7/13/14 | LTE FDD UL Tx −> GPS |
| | Rx |

Referring to Table 1, a mark of “a>b” in the interference pattern illustrates a condition in which a transmitter a causes the in-device coexistence interference to a receiver b. Therefore, in the band 40, the ISM transmitter causes the in-device coexistence interference to an LTE-band downlink TDD receiver (LTE DL TDD Rx). The in-device coexistence interference may be alleviated to some extent by a filtering scheme, but is not sufficient to alleviate the in-device coexistence interference. When a frequency division multiplex (FDM) scheme is additionally applied to the filtering scheme, the in-device coexistence interference may be more efficiently alleviated.

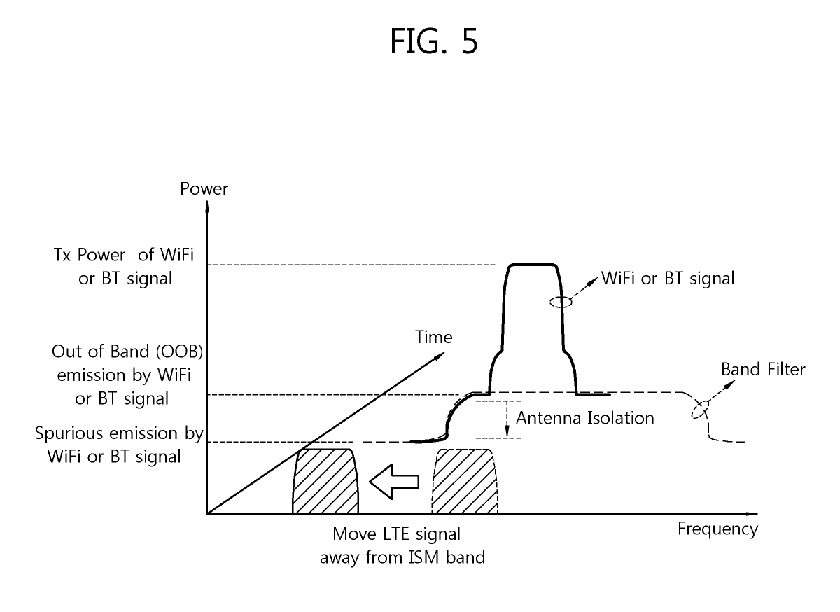

FIG. 5 is an explanatory diagram illustrating one example of alleviating the in-device coexistence interference by using an FDM scheme according to the present invention.

Referring to FIG. 5, the LTE band may be moved so as to prevent the LTE band and the ISM band from overlapping with each other. As a result, a handover of the terminal is induced from the ISM band. However, to this end, a method in which legacy measurement or new signaling accurately triggers a mobility procedure or a radio link failure (RLF) procedure is required. Alternatively, a part which becomes a problem associated with the ISM in the LTE band may be avoided through a filtering or resource allocation technique. Alternatively, overlapping interference may be avoided with respect to a case in which LTE carriers are compiled through a procedure of reconfiguring a set of used carriers.

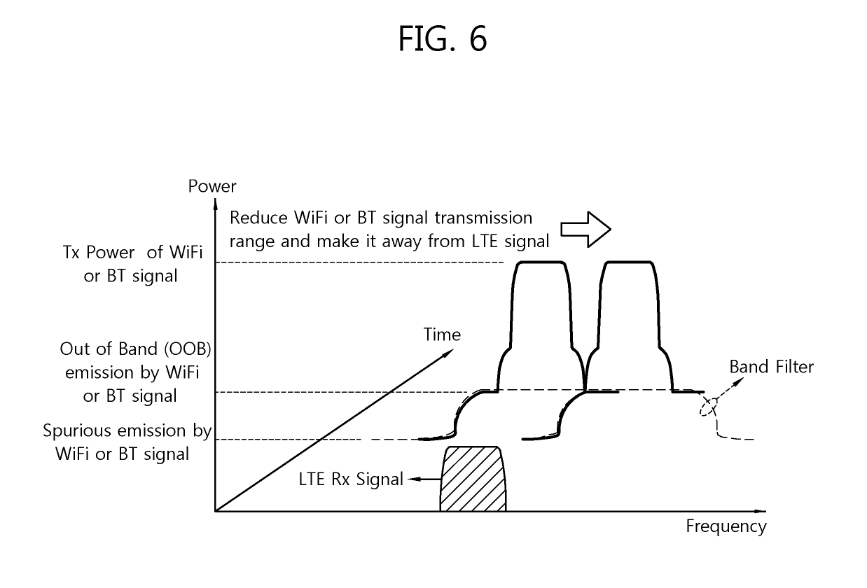

FIG. 6 is an explanatory diagram illustrating another example of alleviating the in-device coexistence interference by using the FDM scheme according to the present invention.

Referring to FIG. 6, the ISM band may be reduced and moved so as to be spaced apart from the LTE band. However, in this scheme, backward compatibility problem may occur. In the case of the Bluetooth, the backward compatibility problem may be resolved due to an adaptive frequency hopping mechanism to some extent, but in the case of the WiFi, it may be difficult to resolve the backward compatibility problem.

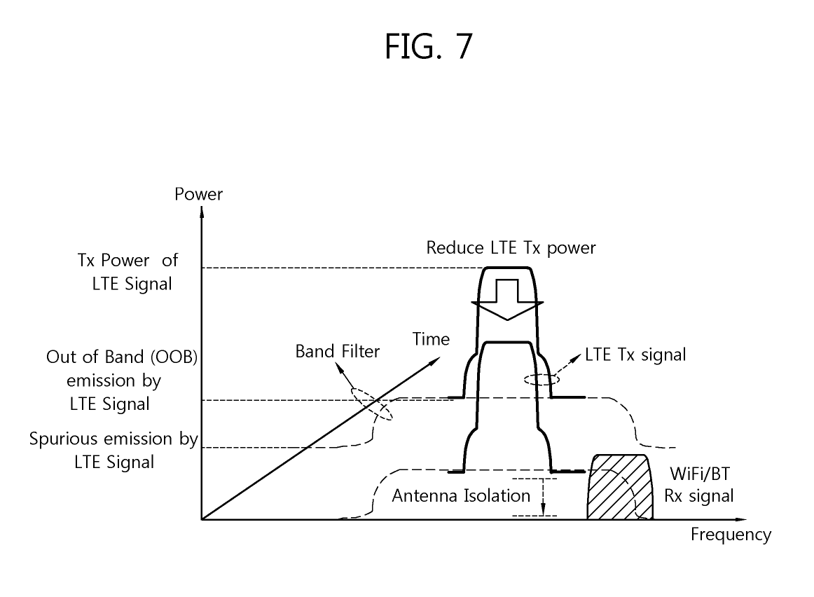

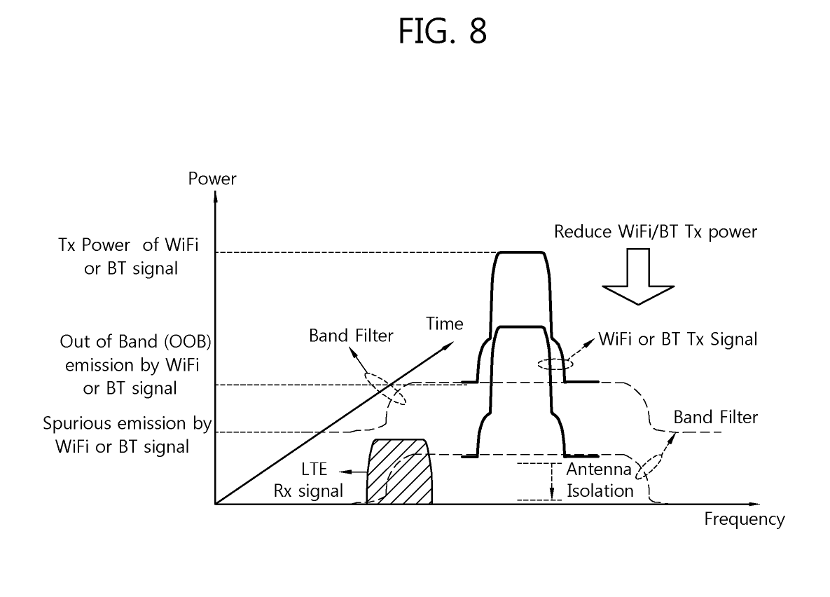

FIGS. 7 and 8 are explanatory diagrams illustrating one example of alleviating the in-device coexistence interference by using a power control (PC) scheme according to the present invention.

Referring to FIG. 7, the terminal avoids the in-device coexistence interference by lowering transmission power of the LTE signal by a predetermined level to improve reception quality of the ISM band and referring to FIG. 8, the terminal avoids the in-device coexistence interference by lowering transmission power of the ISM band by a predetermined level to improve reception quality of the LTE signal.

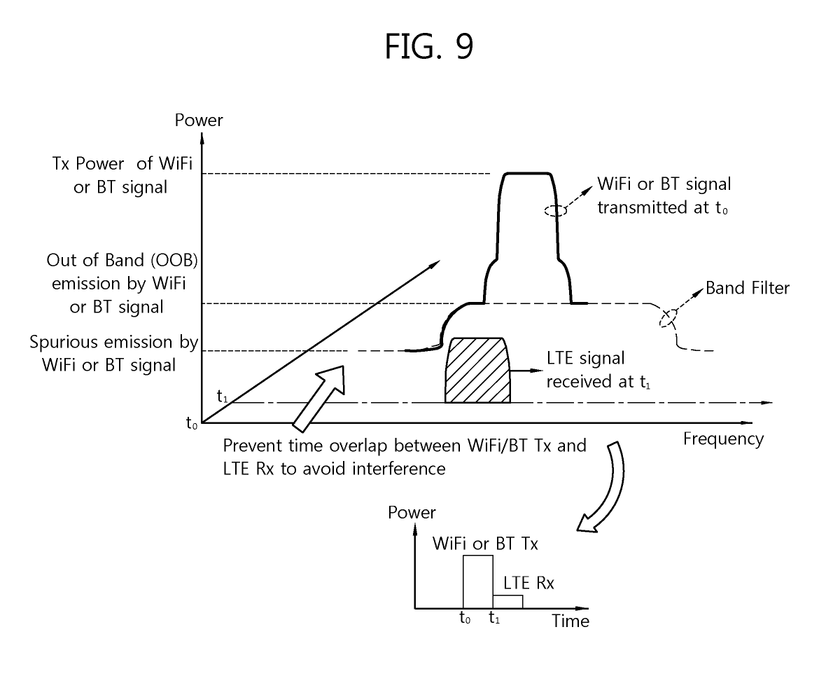

FIG. 9 is an explanatory diagram illustrating one example of alleviating the in-device coexistence interference by using the time division multiplex (TDM) scheme according to the present invention.

Referring to FIG. 9, when a reception time of the LTE signal is prevented from overlapping with a transmission time in the ISM band, the in-device coexistence interference may be avoided. For example, when the signal in the ISM band is transmitted at t0, the LTE signal is received at t1.

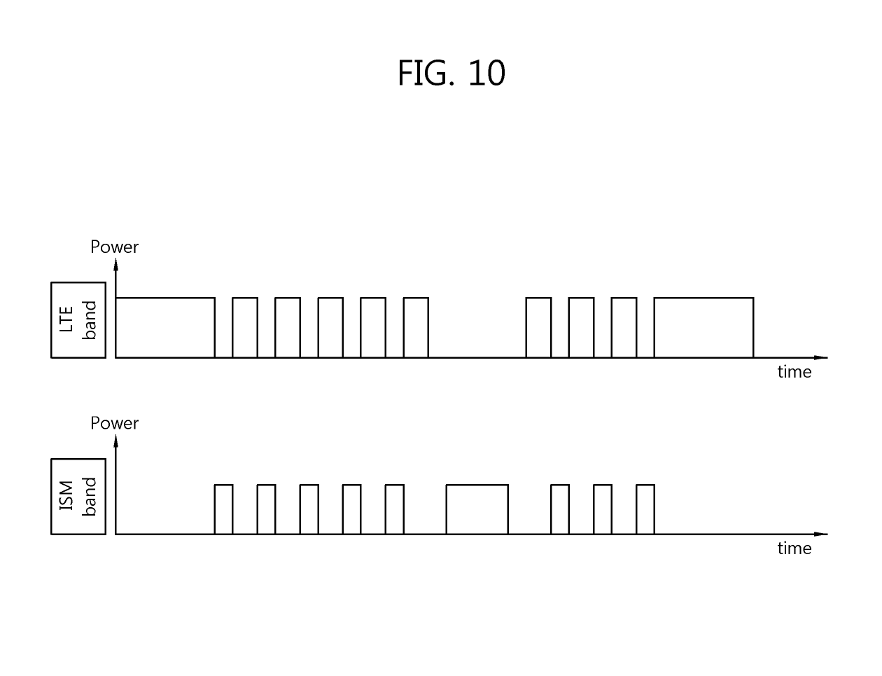

FIG. 10 is an explanatory diagram illustrating one example of transmission/reception timings on time axes in the LTE band and the ISM band using the TDM scheme according to the present invention.

Referring to FIG. 10, the in-device coexistence interference may be avoided without movement between the LTE band and the ISM band by the scheme of FIG. 9.

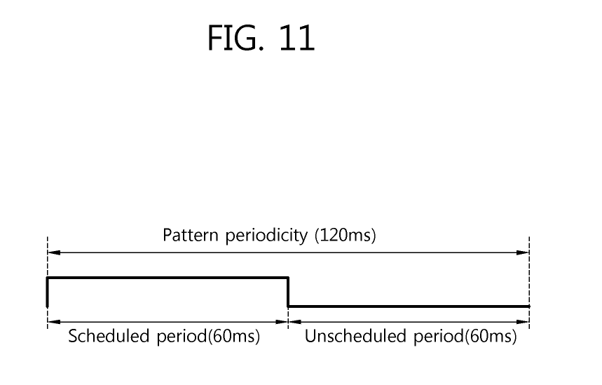

FIG. 11 is a diagram illustrating another example of alleviating the in-device coexistence interference by using the TDM scheme according to the present invention.

Referring to FIG. 11, a predetermined pattern periodicity interval is divided into a scheduled period interval and an unscheduled period interval to avoid the in-device coexistence interference by the TDM scheme based on discontinuous reception (DRX). Mutual interference between the LTE and the ISM is avoided by preventing the LTE from being transmitted within the unscheduled period interval. However, primary LTE transmission such as random access and hybrid automatic repeat request (HARQ) retransmission may be permitted even within the scheduled period interval. Mutual interference between the LTE and the ISM is avoided by preventing the ISM from being transmitted and permitting the LTE to be transmitted within the scheduled period interval. The primary ISM transmission such as Beacon or WiFi may be permitted even within the scheduled period interval, similarly as the unscheduled period interval. The LTE transmission may be prevented in order to protect the primary ISM transmission. Special signaling for protecting the primary ISM transmission such as Beacon may be added. As one example, a period of the Beacon signaling and information on a subframe offset may be added. In this case, the subframe offset number and the system frame number may be determined based on 0. The system frame number may have one of 0 to 1023 by the unit of a radio frame in the LTE system. One radio frame is constituted by ten subframes. When the corresponding subframe offset number and system frame number are known, an accurate frame position may be known in the corresponding system.

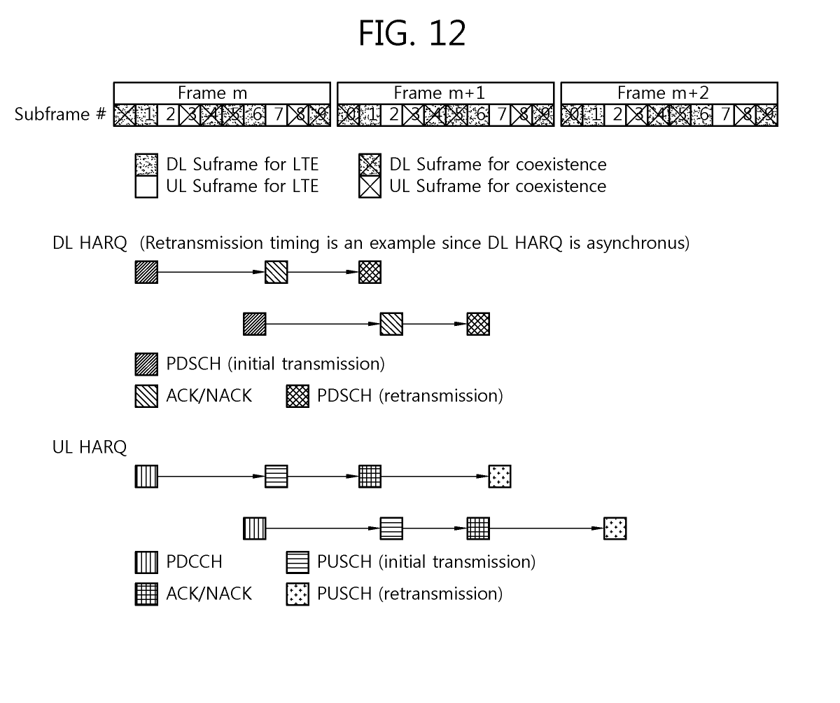

FIG. 12 is a diagram illustrating yet another example of alleviating the in-device coexistence interference by using the TDM scheme according to the present invention.

Referring to FIG. 12, by the TDM scheme based on the HARQ, a retransmission signal is preferably protected when data is transmitted based on the HARQ. Herein, being protected represents that retransmission is achieved without fail. If retransmission is not achieved in order to alleviate or avoid the in-device coexistence interference in the TDM scheme, the performance of the system will remarkably deteriorate. Based on this point, a transmission pattern is determined by considering a retransmission period. For DL transmission, subframes 1 and 6 are reserved in advance and for UL transmission, subframes 2 and 7 are reserved. These are called scheduled subframes. Unscheduled subframes for alleviating the in-device coexistence interference are not used in transmission in order to protect the ISM band.

Even in a scheme based on the HARQ similarly as a scheme based on DRX, the subframes reserved for transmission may be prevented from being transmitted in order to transmit a primary signal in the ISM. On the contrary, even in the unscheduled subframes, primary messages such as random access, system information, and a paging signal may be permitted to be transmitted.

The pattern may be given as a bitmap pattern. That is, the number of subframes indicated by one bit may be one or more. The period of the pattern is “the total length of the bitmap*the number of subframes per bit”, and each bit may be “0” when a subframe directed by the bit is the scheduled subframe and each bit may be “1” when the corresponding subframe is the unscheduled subframe. On the contrary, when each subframe is the scheduled subframe, each bit may be “1” and when each subframe is the unscheduled subframe, each bit may be “0”.

For example, it is assumed that the period is “20”, a pattern expressing the subframe is “1001001000”, the unscheduled subframe is “0”, and the number of the subframes indicated by one bit is two. In the pattern representing the subframe, since first, fourth, and seventh bits are “1”, subframes 0, 1, 6, 7, 12, and 13 are the scheduled subframes every period.

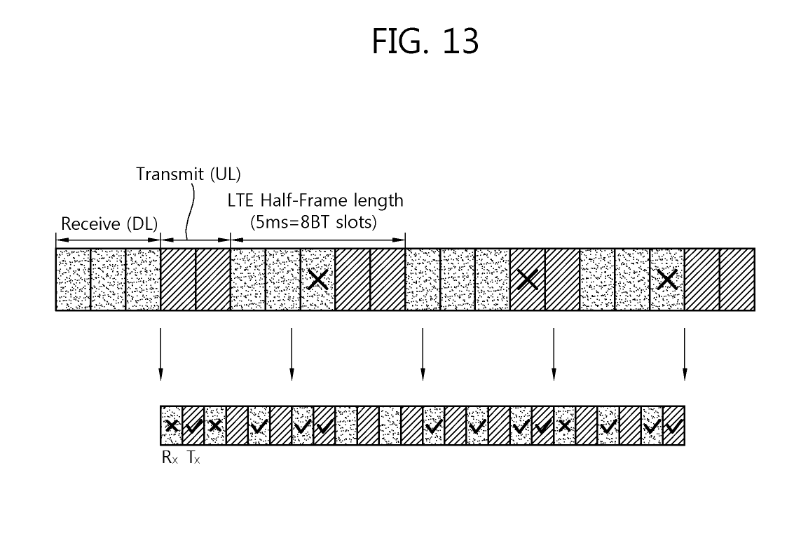

FIG. 13 is a diagram illustrating yet another example of alleviating the in-device coexistence interference according to the present invention.

Referring to FIG. 13, by an autonomously denial scheme, when the in-device coexistence interference occurs in the terminal, transmission of the LTE is denied in order to protect the reception of the ISM. Herein, a ticked part means that transmission or reception is approved and a part marked by “X” means that transmission or reception is denied. Even though UL transmission is granted from the base station, the terminal denies granting not to perform UL transmission in order to protect the reception of the ISM. Similarly, transmission of the ISM is denied in order to protect the reception of the LTE.

According to the present invention, a method of controlling coexistence interference in a device is described.

Hereinafter, the operation of reducing, avoiding, or removing interference will be collectively referred to as ‘interference coordination’.

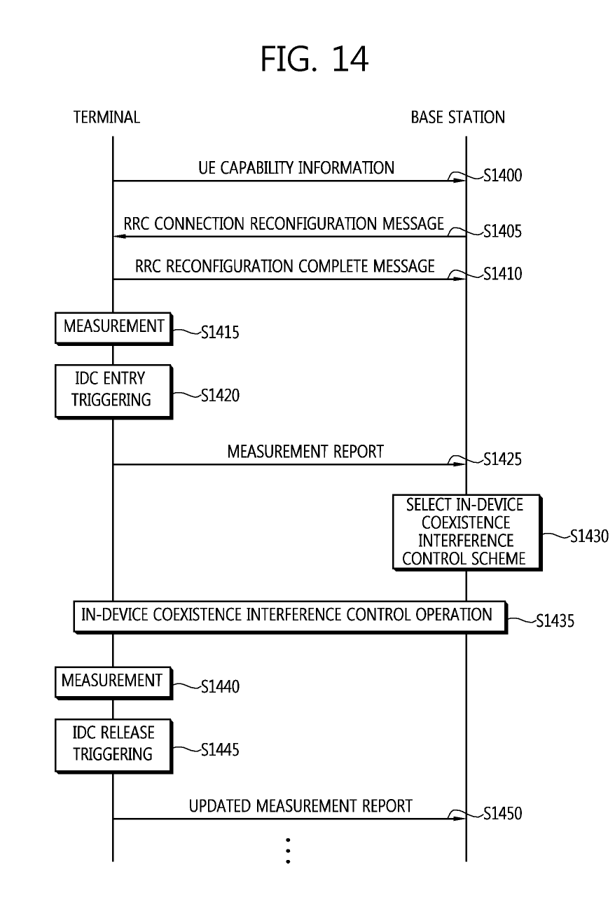

FIG. 14 is a flowchart illustrating an exemplary operation of a terminal and a base station that perform in-device coexistence interference control. An initial setting operation of the terminal is included.

Referring to FIG. 14, the terminal transmits information on capability of the terminal (also referred to as “UE capability information”) to the base station (S1400). The information on the capability of the terminal may include information on whether there is a possibility that in-device coexistence interference exists. Further, the information on the capability of the terminal may include information on a frequency band where in-device coexistence interference may possibly exist. Still further, the information on the capability of the terminal may include information on a frequency band where in-device coexistence interference does not possibly exist. Yet still further, the information on the capability of the terminal may include information on a frequency band where it is determined that in-device coexistence interference does not possibly exist, but there is potential in-device coexistence interference.

Here, the frequency band where in-device coexistence interference possibly exists refers to a frequency band which is likely to be an unusable frequency, and the unusable frequency means a state where in-device coexistence interference is ongoing at the corresponding frequency so that communication at the corresponding frequency is not smoothly done.

As an example, although WiFi is currently off so that the terminal experiences no coexistence interference when gaining initial access to LTE, the terminal is equipped with a WiFi, and thus, determines that a related band 40 may be the unusable frequency due to ongoing IDC, thereby considering the corresponding band as a frequency band where coexistence interference possibly exists.

The following table shows scenarios regarding whether in-device coexistence interference is ongoing.

TABLE 2

| Scenarios | Definition |
|---|---|
| 1 | in-device coexistence interference ongoing in the serving |
| | frequency band |
| 2 | Potential in-device coexistence interference present in the |
| | serving frequency band (currently, in-device coexistence |
| | interference is not ongoing) |
| 3 | In-device coexistence interference ongoing in a frequency |
| | band other than the serving frequency band |
| 4 | Potential in-device coexistence interference present in a |
| | frequency band other than the serving frequency band |
| | (currently, in-device coexistence interference is not ongoing) |

Each scenario represents an interference state with respect to the type of interference and the frequency band. The unusable frequency has nothing to do with whether it is in the serving frequency band or not, so that scenarios 1 and 3 may be considered as ‘in-device coexistence interference being ongoing’.

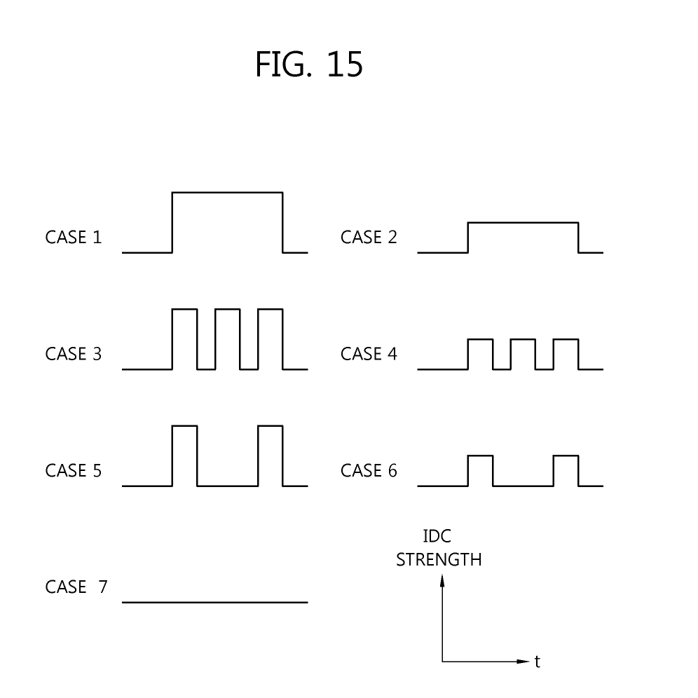

FIG. 15 shows cases where a terminal receives an in-device interference signal. Seven cases may be present with respect to the oftenness and strength (or power) of interference.

Referring to FIG. 15, the seven cases may be classified into four patterns with respect to the oftenness of the interference: cases 1 and 2 into ‘continuous’ pattern, cases 3 and 4 into ‘bursty’ pattern, cases 5 and 6 into ‘sparse’ pattern, and case 7 into ‘none’ pattern.

The seven cases may be divided into three patterns with respect to the strength of interference: cases 1, 3, and 5 into ‘too strong’ pattern, cases 2, 4, and 6 into ‘enough weak’ pattern, and case 7 into ‘none’ pattern.

According to the present invention, in cases 1 and 3, the terminal determines that in-device coexistence interference is ongoing. The above cases represents when interference occurs at least continuously or often and the strength of the interference is very strong.

Meanwhile, the state where in-device coexistence interference has occurred but is not at the unusable frequency and which may be likely changeable to the state where in-device coexistence interference is ongoing is defined as “potential in-device coexistence interference being present”. As an example, cases 2, 4, 5, and 6 are considered “potential in-device coexistence interference being present”. As another example, only case 5 which exhibits very strong strength may be determined as “potential in-device coexistence interference being present”. In the frequency band where the potential in-device coexistence interference is present, handover or RRC configuration/reconfiguration are not impossible and measurement according to the present invention may be done.

On the other hand, the information on the terminal capability may include information that shows ISM capability of the terminal. The terminal may adjust the maximum transmission value of LTE uplink transmission power to reduce interference with the ISM band, and such adjustment of the maximum transmission value may vary depending on the ISM capability of the terminal.

Further, the information on the terminal capability may include an in-device coexistence interference control support indicator (hereinafter, “ICO support indicator”) that indicates whether the terminal has capability to control in-device coexistence interference (ICO capability). This is why if the ICO support indicator indicates that the terminal does not have capability to control the in-device coexistence interference, the base station need not transmit information regarding the control of the in-device coexistence interference to the terminal. For example, when the indicator is 0, it represents that there is no capability to control the in-device coexistence interference, and when the indicator is 1, it represents that there is capability to control the in-device coexistence interference.

Meanwhile, the information on the terminal capability may be included in a terminal capability information message and transmitted, and the terminal capability information message may include a physical layer parameter information entity or a measurement parameter information entity. The physical layer parameter information entity may include information indicating whether to perform an in-device coexistence interference control operation (ICO support indicator). This indicates whether the terminal supports the operation of controlling the in-device coexistence interference. Further, the measurement parameter information entity may include frequency band information. Here, the measurement parameter information entity may be constituted of a list of frequency bands where coexistence interference likely occurs. The frequency band information included in the measurement parameter information entity may include a threshold that serves as a reference for determining whether in-device coexistence interference is ongoing and may include information regarding a frequency band which is not the unusable frequency band but may have potential in-device coexistence interference (potential IDC).

Subsequent to step S1400, the base station transmits an RRC connection reconfiguration message to the terminal (S1405). The RRC connection reconfiguration message may include information that configures measurement performed by the terminal. As an example, the RRC connection reconfiguration message includes a threshold (hereinafter, “IDC triggering threshold”) that is used on the condition of triggering a control operation on in-device coexistence interference. The IDC triggering threshold may be a threshold that has been used for measurement configuration or may be a different inter-frequency measurement-related threshold. For example, the IDC triggering threshold may be a threshold that has been used for triggering an A3 event or A6 event in the corresponding frequency band.

Here, the A3 event is an event that is triggered when a result of measurement of a neighbor cell is larger than that of a primary serving cell by an offset. That is, in case servicing through the neighbor cell is more proper and handover or cell re-selection is required, if the A3 event is triggered, the terminal reports a result of measurement to the base station to proceed with the handover or cell re-selection.

The condition that the terminal triggers entry of the A3 event is as in Equation 1, and the condition that the terminal triggers release of the A3 event is as in Equation 2:

Mₙ+O_{fn}+O_{cn}−HYS>Mₚ+O_{fp}+O_{cp}+Off [Equation 1]

Mₙ+O_{fn}+O_{cn}+HYS<Mₚ+O_{fp}+O_{cp}+Off [Equation 2]

Here, Mₙ is a result of measurement of the neighbor cell without consideration of an offset, and O_{fn} is a frequency specific offset (e.g., an offset value defined a measurement object EUTRA relating to the frequency of the neighbor cell). O_{cn} is a cell specific offset of the neighbor cell (for example, a per-cell offset defined in the measurement object EUTRA relating to the frequency of the neighbor cell), and if nothing is set at the neighbor cell, O_{cn} is “0”. Mₚ is a result of measurement of a primary serving cell without consideration of any offset, and O_{fp} is a frequency (primary frequency)-specific offset of the primary serving cell (for example, an offset defined in the measurement object EUTRA relating to the frequency of the primary serving cell). O_{cp} is a cell-specific offset of the primary serving cell (for example, a per-cell offset defined in the measurement object EUTRA relating to the frequency of the primary serving cell), and if nothing is set at the primary serving secondary servings 0. Hys is a hysteresis parameter for the A3 event, for example, a hysteresis value defined in the report setting EUTRA. Off is an offset parameter for the A3 event, for example, “a3-Offset” defined in the report setting EUTRA. Mₙ and Mₚ are represented in dBm in the case of RSRP (Reference Signal Received Power) and in dB in the case of RSRQ (Reference Signal Received Quality). O_{fn}, O_{cn}, O_{fp}, O_{cp}, Hys, and Off are represented in dB.

The A6 event is an event that is triggered when the result of measurement at the neighbor cell is larger than that of the secondary serving cell by an offset. If the A6 event is triggered, the terminal reports a measurement result for proceeding with the handover or cell re-selection.

The condition for the terminal to trigger entry of the A6 event is as in Equation 3. The condition to trigger release of the A6 event is as in Equation 4. For measurement, the serving cell is assumed as a secondary serving cell set in the frequency band indicated by the relating measurement object EUTRA.

Mₙ+O_{cn}−Hys>Mₛ+O_{cs}+Off [Equation 3]

Mₙ+O_{cn}+Hys<Mₛ+O_{cs}+Off [Equation 4]

Here, Mn is a result of measurement of the neighbor cell without consideration of an offset. Ocn is a cell specific offset of the neighbor cell (for example, a per-cell offset defined in the measurement object EUTRA relating to the frequency of the neighbor cell), and if nothing is set at the neighbor cell, Ocn is “0”. Ms is a result of measurement of a serving cell without consideration of any offset. Ocs is a cell specific offset of the serving cell (for example, a per-cell offset defined in the measurement object EUTRA relating to the serving frequency), and Ocs is 0 if nothing is set at the control signaling. Hys is a hysteresis parameter for the A6 event, for example, a hysteresis value defined in the report setting EUTRA. Off is an offset parameter for the A6 event, for example, “a6-Offset” defined in the report setting EUTRA. Mn and Ms is represented in dBm in the case of RSRP and in dB in the case of RSRQ. Ocn, Ocs, Hys, and Off are represented in dB.

That is, the offset values (Ofn, Ocn, Ofp, Ocp, Ocs, Hys, Off, etc.) which are references for triggering the A3 event or the A6 event may be used as IDC triggering thresholds when the in-device coexistence interference control operation is triggered.

On the other hand, as an example, the IDC triggering thresholds may include an entry threshold and a release threshold, which may be the same as each other. As another example, the IDC triggering thresholds may be values relating to the measurement values of the LTE downlink, and may be used as triggering conditions for the direction of interference from ISM to LTE.

The RRC connection reconfiguration message may further include a remote IDC quantity. The existing report quantity is included in the measurement report configuration information and is information that indicates whether the terminal uses RSRP value, RSRQ value, or both RSRP and RSRQ values when performing measurement.

The report IDC quantity refers to a new type of report quantity that instructs in-device coexistence interference-related measurement information to be included in the measurement report information transmitted from the terminal to the base station when the occurrence of in-device coexistence interference (or entry of the in-device coexistence interference) is triggered. The report IDC quantity may instruct TDM pattern, unusable frequency band or additional measurement result (for example, additional report on measurement that has in-device coexistence interference) to be reported. The report IDC quantity may be a bitmap indicator. The report IDC quantity may be included in the report configuration information entity (measurement configuration information entity) of the RRC connection reconfiguration message.

Subsequently, the terminal transmits an RRC reconfiguration complete message to the base station (S1410). The acknowledgement for the RRC connection reconfiguration message may be included.

The terminal performs measurement considering in-device coexistence interference (measurement including IDC interference) and measurement without consideration of the in-device coexistence interference (measurement excluding IDC interference) (S1415). The terminal distinguishes a portion which is influenced by the in-device coexistence interference from another portion which is not influenced by the in-device coexistence interference and performs measurement using each measurement sample. That is, a measurement sample influenced by the in-device coexistence interference is distinguished from a measurement sample not influenced by the in-device coexistence interference. The rule by which the terminal obtains the measurement sample is referred to as UE internal coordination.

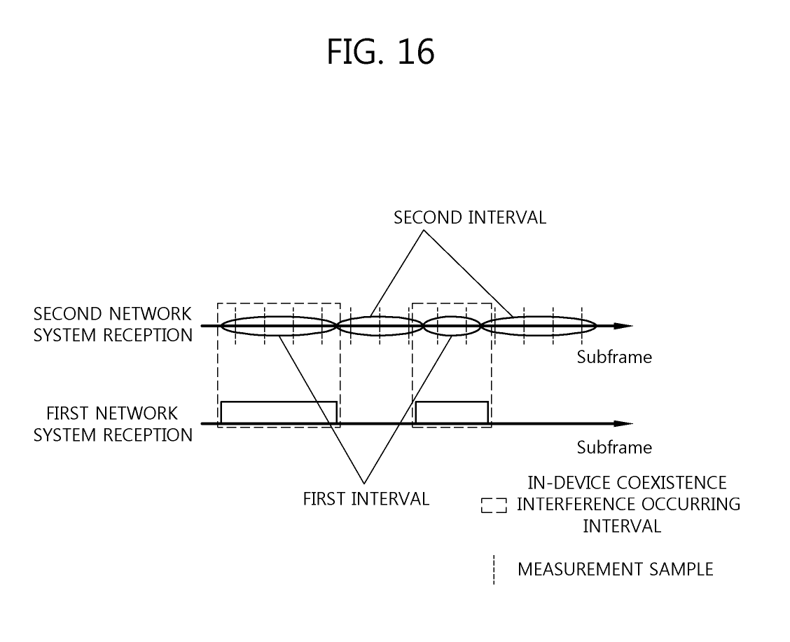

FIG. 16 is a view illustrating performing measurement without consideration of in-device coexistence interference and measurement considering in-device coexistence interference according to the present invention.

Referring to FIG. 16, the terminal obtains a measurement sample influenced by the in-device coexistence interference in a interval (first interval) where in-device coexistence interference occurs and obtains a measurement sample not influenced by the in-device coexistence interference in a interval (second interval) where no in-device coexistence interference occurs. At this time, the terminal may obtain a measurement sample per subframe, or in a predetermined subframe, or in some subframe in each interval. Here, the first network system refers to a network system that provides influence from interference when in-device coexistence interference occurs, and the second network system refers to a network system that is attacked by interference. For example, when ISM receiving end is subjected to interference by the LTE uplink, ISM becomes the second network system. On the contrary, when the receiving end of the LTE downlink is subjected to interference by the ISM transmitting end, the LTE system becomes the second network system.

The measurement sample with no influence from the in-device coexistence interference which is obtained by RSRQ is conceptually as in Equation 5:

$$MeasurementSample = \frac{S}{I + N} \qquad [ Equation 5 ]$$

Here, S is the strength of a received signal in the second network system, I is the strength of the interference signal (but not in-device coexistence interference) that is exerted in the second network system, and N is the strength of noise. That is, the measurement sample means a relative ratio of the interference of received signal to noise.

The measurement sample with no influence from the in-device coexistence interference which is obtained based on RSRP is conceptually as in Equation 6:

MeasurementSample=S [Equation 6]

Here, S is the strength of the received signal in the second network system. That is, the measurement sample means the strength of the received signal at the corresponding serving cell in the second network system.

The measurement sample with influence from the in-device coexistence interference which is obtained based on RSRQ is conceptually as in Equation 7:

$$MeasurementSample = \frac{S}{I + N + {I}^{′}} \qquad [ Equation 7 ]$$

Here, S is the strength of a received signal in the second network system, I is the strength of the interference signal (but not in-device coexistence interference) that is exerted in the second network system, N is the strength of noise, and I′ is the strength of the in-device coexistence interference. That is, the measurement sample means a relative ratio of the interference of received signal to noise.

The measurement sample with no influence from the in-device coexistence interference which is obtained based on RSRP is conceptually as in Equation 8:

MeasurementSample=I′,S+I′,S [Equation 8]

Here, I′ is the strength of the in-device coexistence interference, and S is the strength of the received signal in the second network system. If only the influence from the in-device coexistence interference is measured, the measurement sample is I′, and in case a mixed value of in-device coexistence interference is measured, the measurement sample is S+I′, and in case a value excluding the in-device coexistence interference is measured, the measurement sample is S.

Meanwhile, the entity (for example, terminal) which performs the measurement may be a single entity or may be multiple entities. For example, there may be independently provided an entity that performs measurement considering in-device coexistence interference and an entity that performs measurement with no consideration of in-device coexistence interference.

Meanwhile, the measurement result considering in-device coexistence interference and the measurement result not considering in-device coexistence interference are defined. In general, the measurement result means a value finally calculated via filtering measurement samples. In the case of LTE, the final RSRP and RSRP values are generated through L1 filtering and L3 filtering, and the corresponding values are notified to the base station. The measurement result considering in-device coexistence interference may be a result obtained by performing filtering only on the measurement samples with in-device coexistence interference or may be a result obtained by performing filtering on both the measurement samples with in-device coexistence interference and measurement samples with no in-device coexistence interference. The measurement result not considering in-device coexistence interference may be a result obtained by filtering only the measurement samples with no in-device coexistence interference or may be a result obtained by filtering measurement samples excluding in-device coexistence interference by an interference removal scheme from the measurement samples with in-device coexistence interference together with the measurement samples with no in-device coexistence interference.

Subsequent to step S1415, the terminal triggers an event that indicates that the state where in-device coexistence interference is ongoing has been initiated with respect to the available frequency band (hereinafter, “IDC entry triggering”) (S1420). The measurement result considering in-device coexistence interference and the measurement result not considering in-device coexistence interference are compared with each other, and if a difference between the measurement result considering in-device coexistence interference and the measurement result not considering in-device coexistence interference is larger than the IDC triggering threshold (entry threshold), an event is triggered which indicates that the state where in-device coexistence interference is ongoing (on-going IDC) has been initiated in the corresponding frequency band (hereinafter, “IDC event”). The following equation represents a condition for IDC entry triggering:

M−M′>Th_{entry} [Equation 9]

Here, M is a measurement result not considering in-device coexistence interference, M′ is a measurement result considering in-device coexistence interference, and Thentry is an IDC triggering entry threshold.

The terminal may perform IDC entry triggering only on the serving cell or may perform IDC entry triggering on both the serving cell and the neighbor cell. Here, the phrase “performing IDC entry triggering on both the serving cell and the neighbor cell” means that once either the serving cell or the neighbor cell satisfies the corresponding triggering condition, the IDC event is to be triggered.

As another embodiment, a hysteresis margin may be added to the IDC entry triggering condition. That is, if a value obtained by considering the hysteresis margin in addition to the difference between the measurement result considering in-device coexistence interference and the measurement result not considering in-device coexistence interference is larger than the IDC triggering threshold, the terminal triggers the IDC event. The following equation represents a condition for IDC entry triggering considering the hysteresis margin:

M−M′−Hys>Th_{entry} [Equation 10]

Here, M is the measurement result not considering in-device coexistence interference, M′ the measurement result considering in-device coexistence interference, Thentry the IDC triggering entry threshold, and Hys the hysteresis margin.

As another embodiment, if it is determined based only on the measurement result considering in-device coexistence interference that the measurement result considering in-device coexistence interference is smaller than the IDC triggering threshold, the terminal triggers the IDC event. The hysteresis margin is introduced, and when it is smaller than a value obtained by subtracting the hysteresis margin from the IDC triggering threshold, the terminal may also trigger the IDC event.

As still another embodiment, the terminal may trigger the IDC event based only on the measurement result not considering in-device coexistence interference. That is, the terminal may trigger the IDC event, although it has nothing to do with the in-device coexistence interference, if the A3 event or A6 event operates, based only on the measurement result not considering in-device coexistence interference. At this time, the triggering is triggering for mobility, and by satisfying the triggering conditions for mobility, triggering of the operation of controlling the in-device coexistence interference may also be done. Through the above operation, circumstances associated with the additional in-device coexistence interference may be updated through the triggering for mobility. For example, the unusable band information may be lost.

After performing the measurement, the terminal reports the base station with measurement report information including the measurement result and the in-device coexistence interference indicator (also may referred to as “IDC indication”) (S1425). The in-device coexistence interference indicator may indicate that in-device coexistence interference is ongoing in a specific frequency band of the terminal and may indicate that IDC event is triggered. The measurement report information may be included in the measurement report message.

Further, the measurement report information may include information on an unusable frequency band due to in-device coexistence interference and information on the TDM (Time Division Multiplex) pattern that may be done in the corresponding frequency band. The unusable frequency band information may include information on the range of the frequency band. Or, the unusable frequency band information may include a frequency band indicator used in the LTE band. Or, the unusable frequency band information may include an absolute frequency indicator used in the LTE band (E-UTRA Absolute Radio Frequency Channel Number: EARFCN). Or, the unusable frequency band information may include a cell index, which indicates that the frequency of a cell indicated by the cell index is the unusable frequency band.

The measurement report information may be included in measurement result information element in the measurement report message.

The measurement report information may include the measurement result for only a portion without influence from in-device coexistence interference. Or, the measurement report information may include both the measurement result for a portion without influence from in-device coexistence interference and the measurement result for a portion with influence from in-device coexistence interference. Or, the measurement report information may include the measurement result for a portion without influence from in-device coexistence interference and a difference value between the measurement result for a portion without influence from in-device coexistence interference and the measurement result for a portion with influence from in-device coexistence interference.

Subsequent to step S1425, the base station selects the most appropriate in-device coexistence interference control scheme (ICO scheme) based on the measurement report information (S1430), the base station transfers the in-device coexistence interference control operation (ICO operation) with the terminal, and the control operation is performed between the base station and the terminal (S1435). At this time, the in-device coexistence interference control operation may be an FDM operation or TDM operation. The FDM operation may be done through RRC connection reconfiguration. The TDM operation may be done by indicating the TDM pattern or through DRX (discontinuous reception) reconfiguration. Further, the FDM operation or TDM operation may be the operation described in connection with FIGS. 5 to 13.

As an example, when a problem occurs in the frequency band that provides a service, if it is determined according to the measurement result (or measurement report information) that the problem does not affect the usable frequency band thanks to load balancing and does not greatly influence handover (for example, in case the RSRP or RSRQ value of the corresponding frequency band is great enough), the FDM operation is performed, and otherwise, the TDM may be done by the serving cell.

After performing the operation of controlling in-device coexistence interference, the terminal performs again each of the measurement result considering in-device coexistence interference and the measurement result not considering in-device coexistence interference (S1440). The terminal performs such measurement using the measurement sample of a portion with influence from in-device coexistence interference and the measurement sample of a portion without influence from in-device coexistence interference.

Based on the measurement result, the terminal triggers an event that indicates that the state where in-device coexistence interference is ongoing in the unusable frequency band has been terminated (hereinafter, “IDC release triggering”) (S1445). Here, the phrase “state where in-device coexistence interference is ongoing has been terminated” means that the in-device coexistence interference is small enough or rarely occurs in the corresponding frequency band so that a difficulty in communication has gone.

Under the circumstance where in-device coexistence interference is ongoing, if a difference between the measurement result considering in-device coexistence interference and the measurement result not considering in-device coexistence interference is smaller than the IDC triggering threshold (release threshold), an event may be triggered that indicates that the frequency band which has been determined to be difficult to use due to in-device coexistence interference may be used again. The terminal may perform IDC release triggering only on the serving cell or on both the serving cell or neighbor cell.

The following equation shows a condition for IDC release triggering:

M−M′<Thᵣₑₗₑₐₛₑ [Equation 11]

Here, M is the measurement result not considering in-device coexistence interference, M′ the measurement result considering in-device coexistence interference, and Threlease the IDC triggering release threshold.

As another embodiment, a hysteresis margin may be added to the IDC release triggering condition. That is, if a value obtained by considering the hysteresis margin in addition to a difference between the measurement result considering in-device coexistence interference and the measurement result not considering in-device coexistence interference is smaller than the IDC triggering threshold (release threshold), the terminal may trigger an event that indicates that the frequency band determined to be difficult to use due to in-device coexistence interference may be used again. The following equation shows a condition for IDC release triggering considering the hysteresis margin:

M−M′+Hys<Thᵣₑₗₑₐₛₑ [Equation 12]

Here, M is the measurement result not considering in-device coexistence interference, M′ the measurement result considering in-device coexistence interference, Threlease the IDC triggering release threshold, and Hys the hysteresis margin.

As another embodiment, if it is determined based only on the measurement result considering in-device coexistence interference that the measurement result considering in-device coexistence interference is larger than the IDC triggering threshold, the terminal triggers an event indicating that the frequency band determined to be difficult to use due to in-device coexistence interference may be used again. The hysteresis margin is introduced, and if it is larger than a value obtained by adding the hysteresis margin to the IDC triggering threshold, the terminal may trigger the event as well.

As another embodiment, the terminal may also trigger the event indicating that the frequency band determined to be difficult to use due to in-device coexistence interference may be used again based only on the measurement result not considering in-device coexistence interference. That is, the terminal may trigger the coexistence interference release event irrespective of whether to release the coexistence interference even when operating the A3 event or A6 event based only on the measurement result not considering in-device coexistence interference. The interference release information may be indirectly transmitted by the events triggered by mobility.

The terminal reports the base station with updated measurement report information including the measurement result and in-device coexistence interference indicator (S1450). At this time, the unusable frequency band information would be information updated after the in-device coexistence interference control operation is done. The in-device coexistence interference indicator may include information on the unusable frequency band due to in-device coexistence interference and information on the TDM pattern that may be available at the corresponding frequency. Further, the measurement report information may further include a release report notifying that the state where in-device coexistence interference is ongoing in the unusable frequency band has been terminated.

Thereafter, if the in-device coexistence interference control is further needed, the base station may select the most proper in-device coexistence interference control scheme based on the in-device coexistence interference indicator and the measurement result and may transfer the in-device coexistence interference control operation with the terminal (not shown in the drawings).

On the other hand, according to another embodiment of the present invention, the process of transmitting the terminal capability information in step S1400 may be skipped. In the corresponding embodiment, although the terminal does not transmit, to the base station, possibility for in-device coexistence interference to exist, frequency band that may exist, or ICO support indicator, the base station may be implicitly aware of the terminal's capability.

As an example, in step S1425 or S1450, the terminal transmits the measurement report information including the measurement result and the in-device coexistence interference indicator to the base station irrespective of whether in-device coexistence interference exists. That is, even when the terminal fails to support in-device coexistence interference, the measurement report information should include information associated with in-device coexistence interference. In such case, the information relating to in-device coexistence interference may be a value that does not relate to the actual value or unnecessary values.

As another example, in step S1425 or S1450, the terminal transmits the in-device coexistence interference indicator to the base station. In case the in-device coexistence interference indicator is TRUE, that is, only when in-device coexistence interference exists, the in-device coexistence interference-related information is included in the measurement report information and transmitted to the base station.

As another example, the terminal may transmit through the RRC reconfiguration complete message to the base station information regarding whether there is possibility that in-device coexistence interference exists or information on the frequency band where in-device coexistence interference may likely exist, which is included in the terminal's capability information (step S1410). Further, the terminal may also transmit to the base station through the RRC reconfiguration complete message information on the frequency band where in-device coexistence interference is determined to be unlikely to exist but potential in-device coexistence interference is in existence. Based on this, the terminal may later make report with the measurement result together with the in-device coexistence interference-related information and the base station may receive the in-device coexistence interference-related information.

As another example, the base station may transmit to the terminal configuration information for performing measurement together with system information. The terminal's initial setting operation is performed using the system information transmitted from the base station. The triggering threshold may be included in the system information block (SIB).

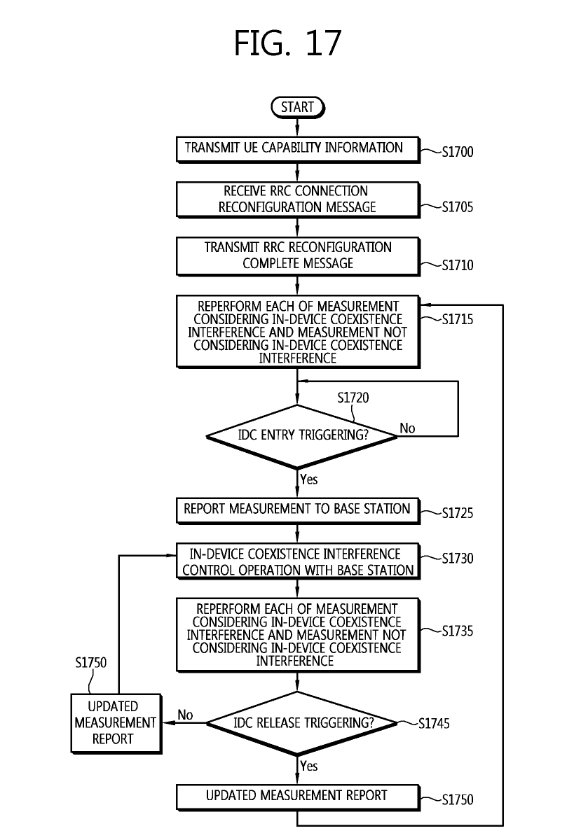

FIG. 17 is a flowchart illustrating a terminal's operation of controlling in-device coexistence interference according to the present invention.

Referring to FIG. 17, the terminal transmits the terminal's capability information to the base station (S1700). The terminal's capability information includes information on whether there is possibility that in-device coexistence interference exists, information on a frequency band where in-device coexistence interference may possibly exist, information on a frequency band where there is no possibility that in-device coexistence interference exists, or information on a frequency band where in-device coexistence interference is determined not to possibly exist but potential in-device coexistence interference is in existence. Further, the terminal's capability information may include information indicating the terminal's ISM capability. Further, the terminal's capability information may include an in-device coexistence interference control support indicator. According to another embodiment, transmission of the terminal's capability information may be skipped.

The terminal receives an RRC connection reconfiguration message from the base station (S1705). The RRC connection reconfiguration message includes information that configures the measurement performed by the terminal (for example, IDC triggering threshold). The IDC triggering threshold may be a threshold used for measurement setting, in particular, a threshold relating to measurement in the same frequency band. For example, the IDC triggering threshold may be a threshold used for triggering the A3 event or A6 event. Further, the RRC connection reconfiguration message may further include a report IDC quantity. The report IDC quantity may instruct TDM pattern, unusable frequency band or additional measurement result (for example, additional report on the measurement with in-device coexistence interference) to be reported.

The terminal transmits the RRC reconfiguration complete message to the base station (S1710). The acknowledgement of reception of the RRC connection reconfiguration message may be included.

The terminal performs each of the measurement considering in-device coexistence interference and the measurement not considering in-device coexistence interference (S1715). The terminal performs the measurement using each measurement sample with a portion with influence from in-device coexistence interference distinguished from a portion without influence from in-device coexistence interference.

The terminal triggers an IDC event indicating that the state where in-device coexistence interference is ongoing has been initiated in the usable frequency band when the triggering condition is met (IDC entry triggering) (S1720). As an example, the measurement result considering in-device coexistence interference is compared with the measurement result not considering in-device coexistence interference, and if a difference between the measurement result considering in-device coexistence interference and the measurement result not considering in-device coexistence interference is larger than the IDC triggering threshold (entry threshold), the IDC event is triggered. The terminal may perform the IDC entry triggering only on the serving cell or on both the serving cell and neighbor cell. As another example, a hysteresis margin is added to the IDC entry triggering condition, and if a value obtained by considering the hysteresis margin in addition to the difference between the measurement result considering in-device coexistence interference and the measurement result not considering in-device coexistence interference is larger than the IDC triggering threshold, the terminal triggers the IDC event. As still another example, if it is determined based only on the measurement result considering in-device coexistence interference that the measurement result considering in-device coexistence interference is smaller than the IDC triggering threshold, the terminal triggers the IDC event. As yet still another example, if it is determined based only on the measurement result considering in-device coexistence interference that it is smaller than a value obtained by subtracting the hysteresis margin from the IDC triggering threshold, the terminal triggers the IDC event. As yet still another example, the terminal may trigger the IDC event based only on the measurement result not considering in-device coexistence interference. That is, the terminal triggers the IDC event simultaneously with the A3 event or A6 event.

The terminal reports the base station with the measurement report information including the measurement result and the in-device coexistence interference indicator (S1725). The in-device coexistence interference indicator may indicate that in-device coexistence interference is ongoing in a specific frequency band of the terminal and may indicate that the IDC event is triggered. The measurement report information may be included in the measurement report message.

The measurement report information may include information on the unusable frequency band due to in-device coexistence interference and information on the TDM pattern that is possible in the corresponding frequency band. The unusable frequency band information may include information on the range of the frequency band. Or, the unusable frequency band information may include a frequency band indicator used in the LTE band. Or, the unusable frequency band information may include an absolute frequency indicator used in the LTE band. Or, the unusable frequency band information may include a cell index.

The measurement report information may include the measurement result for only a portion without influence from in-device coexistence interference. Or, the measurement report information may include both the measurement result for a portion without influence from in-device coexistence interference and the measurement result for a portion with influence from in-device coexistence interference. Or, the measurement report information may include the measurement result for a portion without influence from in-device coexistence interference and a difference value between the measurement result for a portion without influence from in-device coexistence interference and the measurement result for a portion with influence from in-device coexistence interference.

The terminal receives the in-device coexistence interference control operation selected based on the measurement report information (S1730). The control operation is performed between the base station and the terminal. At this time, the in-device coexistence interference control operation may be an FDM operation or TDM operation. The FDM operation may be performed through RRC connection reconfiguration. The TDM operation may be performed by indicating TDM pattern or through DRX reconfiguration. Further, the FDM operation or TDM operation may be an operation as described in connection with FIGS. 5 to 13.

The terminal performs again the measurement considering in-device coexistence interference and the measurement not considering in-device coexistence interference (S1735). The terminal performs the measurement using the measurement sample of a portion with influence from in-device coexistence interference and the measurement sample of a portion without influence from in-device coexistence interference.

Based on the measurement result, the terminal triggers an event indicating that the state where in-device coexistence interference is ongoing in the unusable frequency band has been terminated (IDC release triggering) (S1740). The terminal may perform the IDC release triggering only on the serving cell or on both the serving cell and neighbor cell.

As an example, under the circumstance where in-device coexistence interference is ongoing, if in the unusable frequency band a difference between the measurement result considering in-device coexistence interference and the measurement result not considering in-device coexistence interference is smaller than the IDC triggering threshold (release threshold), the IDC release triggering is performed. As another example, the hysteresis margin is added to the IDC release triggering condition, and if a value obtained by considering the hysteresis margin in addition to the difference between the measurement result considering in-device coexistence interference and the measurement result not considering in-device coexistence interference is smaller than the IDC triggering threshold (release threshold), the IDC release triggering is performed.

As sill another example, if it is determined based only on the measurement result considering in-device coexistence interference that the measurement result considering in-device coexistence interference is larger than the IDC triggering threshold, the terminal performs the IDC release triggering.

As still another example, if it is determined based only on the measurement result considering in-device coexistence interference that the measurement result considering in-device coexistence interference is larger than a value obtained by adding the hysteresis margin to the IDC triggering threshold, the terminal performs the IDC release triggering.

As still another example, the terminal performs the IDC release triggering based only on the measurement result not considering in-device coexistence interference. That is, the terminal may perform the IDC release triggering simultaneously with the A3 event or A6 event.

The terminal reports the base station with the updated measurement report information including the measurement result and the in-device coexistence interference indicator (S1745). At this time, the unusable frequency band information is information updated after the in-device coexistence interference control operation is done. Further, the measurement report information may further include a release report notifying that the state where in-device coexistence interference is ongoing has been terminated in the unusable frequency band.

Thereafter, if the in-device coexistence interference control is further needed, the terminal may receive the selected in-device coexistence interference control operation to thereby repeat the control operation (S1730).

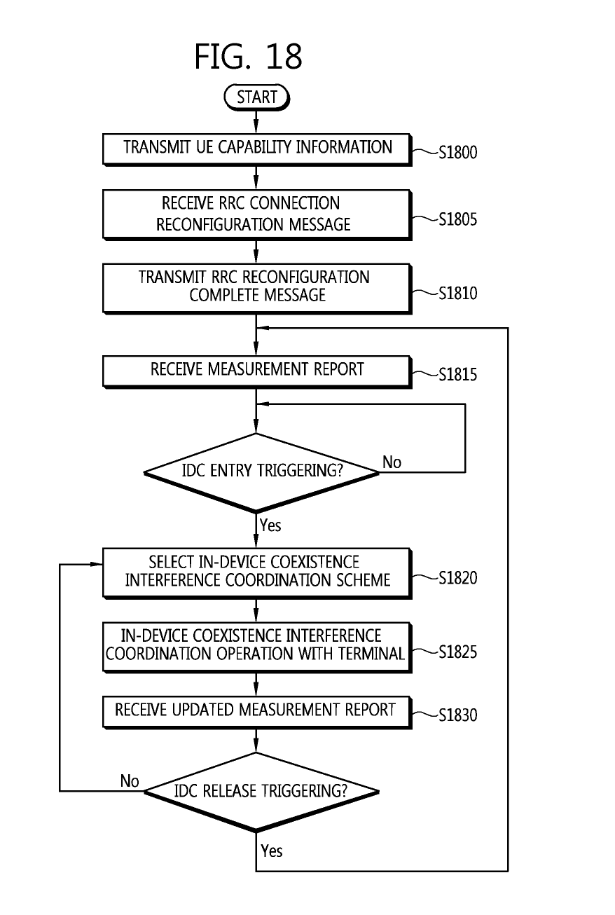

FIG. 18 is a flowchart illustrating an operation of a base station to control in-device coexistence interference according to the present invention.

Referring to FIG. 18, the base station receives terminal's capability information from the terminal (S1800). The terminal's capability information includes information on whether there is possibility that in-device coexistence interference exists, information on a frequency band where in-device coexistence interference may possibly exist, information on a frequency band where there is no possibility that in-device coexistence interference exists, or information on a frequency band where in-device coexistence interference is determined not to possibly exist but potential in-device coexistence interference is in existence. Further, the terminal's capability information may include information indicating the terminal's ISM capability. Further, the terminal's capability information may include an in-device coexistence interference control support indicator.

The base station transmits the RRC connection reconfiguration message to the terminal (S1805). The RRC connection reconfiguration message includes information that configures the measurement performed by the terminal (for example, IDC triggering threshold). The IDC triggering threshold may be a threshold used for measurement setting, in particular, measurement-related threshold in the same frequency band. For example, the IDC triggering threshold may be a threshold used for the A3 event or A6 event. Further, the RRC connection reconfiguration message may further include a report IDC quantity. The report IDC quantity may instruct TDM pattern, unusable frequency band or additional measurement result (for example, additional report for measurement with in-device coexistence interference) to be reported.

The base station receives the RRC reconfiguration complete message from the terminal (S1810). The acknowledgement of reception of the RRC connection reconfiguration message may be included.

The base station receives from the terminal measurement report information including an in-device coexistence interference indicator and the measurement result considering in-device coexistence interference and measurement result not considering in-device coexistence interference (S1815). The in-device coexistence interference indicator may indicate that in-device coexistence interference is ongoing in a specific frequency band of the terminal, and may indicate that the IDC event is triggered. The measurement report information may be included in the measurement report message.

The measurement report information may include information on the unusable frequency band due to in-device coexistence interference and information on the TDM pattern that is possible in the corresponding frequency band. The unusable frequency band information may include information on the range of the frequency band. Or, the unusable frequency band information may include a frequency band indicator used in the LTE band. Or, the unusable frequency band information may include an absolute frequency indicator used in the LTE band. Or, the unusable frequency band information may include a cell index.

The measurement report information may include the measurement result for only a portion without influence from in-device coexistence interference. Or, the measurement report information may include both the measurement result for a portion without influence from in-device coexistence interference and the measurement result for a portion with influence from in-device coexistence interference. Or, the measurement report information may include the measurement result for a portion without influence from in-device coexistence interference and a difference value between the measurement result for a portion without influence from in-device coexistence interference and the measurement result for a portion with influence from in-device coexistence interference.

In case the in-device coexistence interference indicator indicates that IDC entry triggering is done, the base station selects the most proper in-device coexistence interference control scheme based on the measurement report information (S1820) and transfers the in-device coexistence interference control operation with the terminal, and the control operation is performed between the base station and the terminal (S1825). At this time, the in-device coexistence interference control operation may be an FDM operation or TDM operation. The FDM operation may be performed through RRC connection reconfiguration. The TDM operation may be performed by indicating TDM pattern or through DRX reconfiguration. Or, the FDM operation or TDM operation may be an operation as described in connection with FIGS. 5 to 13.

The base station receives the updated measurement report information from the terminal (S1830). At this time, the unusable frequency band information is information updated after the in-device coexistence interference control operation is done. Further, the measurement report information may further include a release report notifying that the state where in-device coexistence interference is ongoing in the unusable frequency band has been terminated.

In case the in-device coexistence interference indicator indicates that IDC release triggering is not done, that is, when the in-device coexistence interference control is further needed, the base station reselects a proper in-device coexistence interference control scheme (S1820) and transfers the in-device coexistence interference control operation to the terminal, thereby repeating the control operation (S1825).

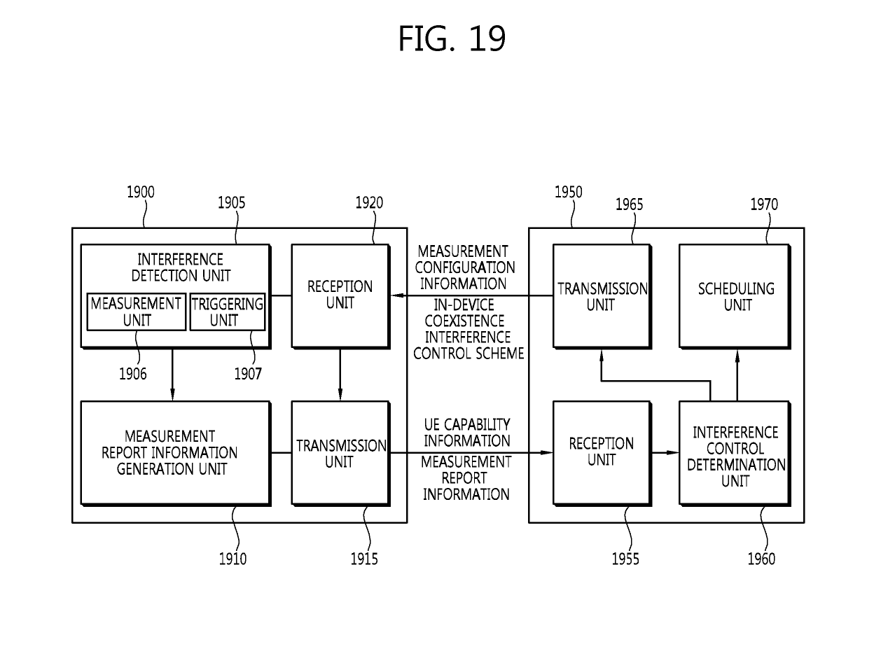

FIG. 19 is a block diagram illustrating an apparatus of transmitting and receiving information regarding in-device coexistence interference according to an embodiment of the present invention.

Referring to FIG. 19, a terminal (or called as a ‘UE’) 1900 and a base station 1950 exchange information regarding in-device coexistence interference. The information on in-device coexistence interference includes support information transmitted from the terminal 1900 and response information transmitted from the base station 1950.

The terminal 1900 includes an interference detection unit 1905, a measurement report information generation unit 1910, a transmission unit 1915, and a reception unit 1920.

The interference detection unit 1905 detects occurrence of in-device coexistence interference. For example, when in-device coexistence interference occurs-a situation where while the terminal 1900 is receiving signal x from the base station 1950 through LTE RF, the terminal 1900 transmits signal y through another RF, such as WiFi, this is detected. Also, the interference detecting unit 1905 detects interference of the frequency band which is in a state where in-device coexistence interference is ongoing at the corresponding frequency so that communication at the corresponding frequency is not smoothly done (unusable frequency).

The interference detection unit 1905 includes a measurement unit 1906 and a triggering unit 1907. The measurement unit 1906 performs measurement not considering in-device coexistence interference and measurement considering in-device coexistence interference. The measurement unit 1906 performs measurement using each measurement sample with a portion with influence from in-device coexistence interference distinguished from a portion without influence from in-device coexistence interference. Measurement is performed based on the measurement configuration information received from the base station. Here, the measurement unit 1906 may obtain the measurement samples in one module or in two modules, respectively.

When the triggering condition (IDC entry triggering or IDC release triggering) is met, the triggering unit 1907 triggers an event indicating that the state where in-device coexistence interference is ongoing has been initiated in the usable frequency band or an event indicating that the in-device coexistence interference has been terminated in the unusable frequency band using the IDC triggering threshold received from the base station.

The triggering unit 1907 may use the offset values (Ofn, Ocn, Ofp, Ocp, Ocs, Hys, Off, etc.) which are references for triggering the A3 event or the A6 event as IDC triggering thresholds when the in-device coexistence interference control operation is triggered.

The measurement report information generation unit 1910 generates measurement result information including the measurement result and an in-device coexistence interference indicator. The in-device coexistence interference indicator indicates that IDC triggering has been performed, and the measurement report information may include information on the unusable frequency band due to in-device coexistence interference and information on TDM pattern that may be available in the corresponding frequency band. The measurement report information may include the measurement result for only a portion without influence from in-device coexistence interference. Or, the measurement report information may include both the measurement result for a portion with influence from in-device coexistence interference and measurement result for a portion without influence from in-device coexistence interference. Or, the measurement report information may include the measurement result for a portion without influence from in-device coexistence interference and a difference value between the measurement result for a portion with influence from in-device coexistence interference and the measurement result for a portion without influence from in-device coexistence interference.

When information constituting the measurement report information is updated, the measurement report information generation unit 1910 generates the updated measurement report information.

The transmission unit 1915 transmits terminal's capability information and measurement report information to the base station 1950. The terminal's capability information includes information on whether there is possibility that in-device coexistence interference exists, information on a frequency band where in-device coexistence interference may possibly exist, information on a frequency band where there is no possibility that in-device coexistence interference exists, or information on a frequency band where in-device coexistence interference is determined not to possibly exist but potential in-device coexistence interference is in existence.

When the measurement report information is updated, the transmission unit 1915 transmits the updated measurement report information back to the base station 1950.

The reception unit 1920 receives the measurement configuration information from the base station 1950. The measurement configuration information may include a threshold constituting an IDC triggering condition, and may be included in the RRC connection reconfiguration message and then transmitted.

Further, the reception unit 1920 receives the in-device coexistence interference control operation determined by the base station 1950. At this time, the in-device coexistence interference control operation may be an FDM operation or TDM operation.

The base station 1950 includes a reception unit 1955, an interference control determination unit 1960, a transmission unit 1965, and a scheduling unit 1970.

The reception unit 1955 receives the terminal's capability information and the measurement report information from the terminal 1900.

The interference control determination unit 1960 determines the in-device coexistence interference control operation based on the measurement report information received from the terminal 1900. The in-device coexistence interference control operation may be an FDM operation or TDM operation.

The transmission unit 1965 transmits the measurement configuration information configuring the measurement of the terminal 1900 to the terminal 1900 through the RRC connection reconfiguration message.

Further, the transmission unit 1965 transmits the in-device coexistence interference control operation determined by the interference control determination unit 1960 to the terminal 1900.

The scheduling unit 1970 performs the in-device coexistence interference control operation as an FDM operation or TDM operation depending on the determination of the interference control determination unit 1960. The FDM operation may be performed through the RRC connection reconfiguration. The TDM operation may be performed by indicating TDM pattern or through DRX reconfiguration. Further, the FDM operation or TDM operation may be an operation as described in connection with FIGS. 5 to 13.

In said example system, methods is described based on flow charts by sequential steps and blocks, but the present invention is not limited to the order of the steps, the steps are not exclusive but may include any other step(s), or one of more steps may be deleted in the flow chart.

While the present invention has been shown and described in connection with the embodiments, it will be apparent to those skilled in the art that modifications and variations can be made without departing from the spirit and scope of the invention as defined by the appended claims.

1. A method of controlling in-device coexistence interference (IDC) by a terminal in a wireless communication system, the method comprising the steps of:
receiving from a base station measurement configuration information including an IDC triggering threshold used for the condition of triggering an event indicating whether on-going IDC has been initiated;
performing each of measurement considering IDC and measurement not considering IDC based on the measurement configuration information;
triggering the event when a difference between a result of the measurement considering IDC and a result of the measurement not considering IDC is larger than the IDC triggering threshold; and
reporting to the base station an IDC indication indicating whether the event is triggered and the results of the measurements.

2. The method of claim 1, further comprising the step of transmitting capability information of the terminal to the base station, wherein the capability information of the terminal is a one-bit indicator indicating whether the terminal has capability to control IDC.

3. The method of claim 1, further comprising the step of transmitting capability information of the terminal to the base station, wherein the capability information of the terminal is a two-bit indicator, which includes one bit indicating whether the terminal has capability to control IDC and one bit indicating whether to support an arbitrary declining operation.

4. The method of claim 1, further comprising the step of transmitting to the base station capability information of the terminal including a possibility that IDC exists, a frequency band where IDC possibly exists, or an indicator indicating whether the terminal has capability to control IDC before the step of receiving the measurement configuration information from the base station.

5. The method of claim 1, wherein the IDC triggering threshold includes a triggering threshold for triggering when which a result of measurement of a neighbor cell is larger than measurement of a primary serving cell by an offset or a triggering threshold for triggering when which a result of measurement of a neighbor cell is larger than measurement of a secondary serving cell by an offset.

6. The method of claim 1, wherein the step of triggering the event includes triggering the event when a value obtained by subtracting a hysteresis value from a difference between the result of the measurement considering IDC and the result of the measurement not considering IDC is the IDC triggering threshold.

7. A method of controlling in-device coexistence interference (IDC) by a base station in a wireless communication system, the method comprising the steps of:
transmitting to a terminal measurement configuration information including a condition for triggering an event that indicates whether on-going IDC has been initiated;
receiving from the terminal an IDC indication indicating whether the event is triggered and a result of measurement performed based on the measurement configuration information;
determining an IDC control operation based on the result of the measurement and the IDC indication; and
transmitting the IDC control operation to the terminal.

8. The method of claim 7, further comprising the step of receiving capability information of the terminal from the base station, wherein the capability information of the terminal is a one-bit indicator indicating whether the terminal has capability to control IDC.

9. The method of claim 7, further comprising the step of transmitting capability information of the terminal to the base station, wherein the capability information of the terminal is a two-bit indicator, which includes one bit indicating whether the terminal has capability to control IDC and one bit indicating whether to support an arbitrary declining operation.

10. The method of claim 7, further comprising the step of receiving from the terminal capability information of the terminal including a possibility that IDC exists, a frequency band where IDC possibly exists, or an indicator indicating whether the terminal has capability to control IDC before the step of transmitting the measurement configuration information to the terminal, wherein the measurement configuration information is generated based on the capability information of the terminal.

11. The method of claim 7, wherein the measurement configuration information further includes a report IDC quantity indicating that the measurement report information is set to include IDC related information.

12. A terminal that controls in-device coexistence interference (IDC) in a wireless communication system, the terminal comprising:
a reception unit receiving from a base station measurement configuration information including an IDC triggering threshold used on the condition of triggering an event indicating whether on-going IDC has been initiated;
a measurement unit performing each of measurement considering IDC and measurement not considering IDC based on the measurement configuration information;
a triggering unit triggering the event when a difference between a result of the measurement considering IDC and a result of the measurement not considering IDC is larger than the IDC triggering threshold; and
a transmission unit reporting to the base station an IDC indication indicating whether the event is triggered and the results of the measurements.

13. A base station that controls in-device coexistence interference (IDC) in a wireless communication system, the base station comprising:
a transmission unit transmitting to a terminal measurement configuration information including a condition for triggering an event that indicates whether on-going IDC has been initiated;
a reception unit receiving from the terminal an IDC indication indicating whether the event is triggered and a result of measurement performed based on the measurement configuration information; and
an interference control determination unit determining an IDC control operation based on the measurement report information.
